(19) United States
(12) Patent Application Publication
(10) Pub. No.: US 2022/0189256 A1
(43) Pub. Date: Jun. 16, 2022

(54) SYSTEM AND METHOD FOR CONDUCTING ONLINE VIDEO GAME TOURNAMENTS AND MATCHES

(71) Applicant: Ryvals, Inc., Sheridan, WY (US)

(72) Inventors: Christopher Shaya, Frisco, TX (US); Sean Murphy, Frisco, TX (US); Michael Martin, Zachary, LA (US)

(73) Assignee: Ryvals, Inc., Sheridan, WY (US)

(21) Appl. No.: 17/359,485

(22) Filed: Jun. 25, 2021

Related U.S. Application Data
(60) Provisional application No. 63/125,336, filed on Dec. 14, 2020.

(51) Int. Cl. G07F 17/32; G06Q 20/36; G06Q 20/38

(52) U.S. Cl. CPC G07F 17/3279; G07F 17/3258; G06Q 2220/00; G06Q 20/367; G06Q 20/382; G07F 17/323

(57) ABSTRACT

Disclosed is a system and method for conducting online video gaming tournaments and contests. The invention is directed to a plurality of networked gaming devices, a plurality of gaming servers, a plurality of contestant digital accounts, a plurality of database servers and memory storing readable instructions to execute a method for operating a system and of conducting online video game tournaments and matches includes the steps of providing contestants, collecting a required entry fee from contestant digital accounts, organizing players into a match, beginning the match, collecting statistics from a match, reviewing statistics from the match and tallying game metrics such as opponents eliminated or assist count, ranking contestants according to tallied game metrics, and paying out contestants according to tallied game metrics.

### CROSS-REFERENCE TO RELATED APPLICATIONS

The present utility patent application claims priority benefit of the U.S. provisional application for patent Ser. No. 63/125,336 titled “System and Method for Conducting Online Video Game Tournaments and Matches” filed on Dec. 14, 2020 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of online video games. More specifically, the present invention relates to a system and method of conducting online video game tournaments and matches.

### 2. Description of the Related Art

Video gaming has become immensely popular in today's connected world. In 2018, the video game industry generated more than $131 billion, and is likely to become a $300 billion industry by 2025.

Video game players represent a diverse cross-section of the global population representing virtually every age group, gender group and ethnic background. Video games connect people of all backgrounds. Regardless of gender, age, and/or socioeconomic status, when people sit to compete, they are all equal. Video games build new communities by connecting people who may otherwise never meet. Today, the average gamer spends over 7 hours a week playing video games, playing on average 1 hour and 22 minutes per sitting.

One of the most popular genres of video games currently being played are known as first-person shooter games. Such video games are centered on gun and other weapon-based combat shown in a first-person perspective, with the player experiencing the action through the eyes of a character and controlling the player character in a three-dimensional space. This genre of video game has given rise to the battle royale tournament where dozens to hundreds of players start with minimal equipment and then battle to eliminate all other opponents while avoiding being trapped outside of a shrinking “safe area,” with the winner being the last player or team alive. In a recent study, video gamers of the age 18-25 demographic prefer to play first-person shooter and battle royale games, such as Call of Duty® by Activision®, and Fortnite® by Epic Games®.

Such video gaming tournaments have given rise to the esports industry. The esports industry revolves around online video game tournaments. Whether such tournaments are hosted by third-party companies or a certain video game's developer, such tournament events are the beginning and end of their games' competitive scene. Esports gaming centers and arenas are growing in popularity, with tournaments now being televised and streamed online worldwide. It has been reported that roughly 36 percent of video game players would quit their jobs if they could support themselves as a professional video game player. It has been further reported that over 57% of male video game players aged 18-35 wish to become professional video game players.

The esports industry is now a billion-dollar industry with few signs of slowing growth. With more and more esports tournaments available now than ever before, demand for more entertaining and more lucrative player experiences has increased. Currently, the esports ecosystem is fractured, though, creating challenges for both casual and hardcore video game players alike. Such challenges include location based demand such as esports venues, college campuses, bars and restaurants, and other local-in-nature venues. Another challenge is providing an online tournament environment that attracts competitive video game players. Other challenges include wagering and tournament payout structures. Finally, there is a need for a unifying platform where players can play, compete, qualify, and even support themselves financially.

Based on the foregoing, it is overwhelmingly clear that there exists a need for an improved system and method of conducting online video game tournaments and matches that integrates esports tournament environments with a payout structure based on the number of opponents defeated or kills made.

### SUMMARY

The object of the present invention is to provide a system and method for conducting online video game tournaments and contests. The invention provides an improved system and method of conducting online video game tournaments and matches that integrates game servers, database servers, and contestant accounts to create a gaming environment that offers players payouts on a “pay-per-kill” basis.

At its essence, the system and method for conducting online video gaming tournaments and contests is directed to a plurality of networked gaming devices, each gaming device having a processor, memory and an interface programmed to communicate with a plurality of gaming servers having a processor memory and an input/output means, a plurality of contestant digital accounts, the contestant accounts being accessible on a networked computer system, the system having a processor, memory, and an interface, a plurality of gaming servers, each gaming server having an application programming interface programmed to communicate with the plurality of gaming devices, a plurality of database servers, each database server having an application programming interface programmed to communicate with the plurality of gaming servers and said plurality of contestant digital accounts, and memory storing computer readable instructions that, when executed by at least one processor in the said plurality of gaming servers or plurality of database servers to cause the system for conducting an online video game tournament and matches comprising at least one gaming device, at least one gaming server, at least one database server and at least one client digital account, for each of a plurality of steps including providing contestants, collecting a required entry fee from contestant digital accounts, organizing players into a match, beginning the match, collecting statistics from a match, reviewing statistics from the match and tallying game metrics such as opponents eliminated or assist count, ranking contestants according to tallied game metrics, and paying out contestants according to tallied game metrics.

The system and method of conducting online video game tournaments and matches offers game ready technology and can be readily implemented in location-based settings such as esports arenas, local venues or demographically specific locations such as, but not limited to, college campuses. Alternatively, the system and method of conducting online video game tournaments can be implemented as a purely networked system wherein players play in online video gaming tournaments with a pay-per-kill feature. Such a system and method can be readily implemented by game publishers and/or developers and third-party providers alike.

Such a system can allow institutions to operate their entire esports ecosystem with other institutions through a single integrated platform. The system can be further configured to aid educational or other nonprofit institutions in generating donors, adding revenue sources, and creating esports scholarships through revenues generated by gamer entry fees as well as advertising. The system and method of conducting online video game tournaments and matches can be configured to include wagering and tournament payout structures. Alternatively, the system and method of conducting online video game tournaments and matches can be configured to include non-monetary prizes such as trophies, certificates, non-fungible tokens, gaming tokens and the like. Most importantly, the system and method of conducting online video game tournaments provides a unifying platform where players of all skillsets can play, compete, qualify for bigger tournaments, and even support themselves financially.

The system and method of conducting online video game tournaments and matches can be readily implemented across a wide variety of forms and configurations. Such forms and configurations are largely directed to video gaming devices. However, the present invention can be readily implemented across a wide variety of mobile technologies such as, but not limited to, smartphone and tablet applications. Moreover, applications of the invention can be readily implemented in software, which can be stored on a readable medium (i.e. hard disk, cloud storage, CD-ROM, flash memory, etc.) and used with a computer system either as a stand-alone application or over a network and/or client-server system.

### BRIEF DESCRIPTION OF THE DRAWINGS

The invention directed by way of example, and not by way of limitation, in the figures of the accompanying drawings and in which like reference numerals refer to similar elements and in which:

FIG. 1 illustrates a diagram view of the system for conducting online video game tournaments and matches in accordance with an embodiment of the invention;

FIG. 2 illustrates a network diagram in which the exemplary automated till register system may be implemented;

FIG. 3 illustrates a typical computer system that, when appropriately configured or designed, may serve as a computer system for which the system and method of conducting online video game tournaments and matches, and the components thereof, may be embodied;

FIG. 4 illustrates a network diagram in which the exemplary system and method of conducting online video game tournaments and matches may be implemented;

FIG. 5 illustrates a flowchart depicting a general method for conducting online video game tournaments and matches in accordance with an embodiment of the invention;

FIG. 6 illustrates a block diagram depicting a tournament structure conducted by the system and method of conducting online video game tournaments and matches in accordance with an embodiment of the invention;

FIG. 7 illustrates an example of competitor payouts in accordance with an embodiment of the invention;

FIG. 8 illustrates a block diagram representing a simple blockchain;

FIG. 9 illustrates a block diagram representing details of each block and transaction in the blockchain of FIG. 8; and

FIG. 10 illustrates a sample user interface for a contestant account in accordance with an embodiment of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

A “computer” may refer to one or more apparatus and/or one or more systems that are capable of accepting a structured input, processing the structured input according to prescribed rules, and producing results of the processing as output. Examples of a computer may include: a personal computer (PC); a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer; a personal digital assistant (PDA); a portable telephone; a portable smartphone; wearable devices such as smartwatches; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

The term “processor” may refer to any device or portion of a device that processes electronic data from registers and/or memory to transform that electronic data into other electronic data that may be stored in registers and/or memory. A “computing platform” may comprise one or more processors.

An “algorithm” is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

It will be readily understood by persons skilled in the art that the various methods and algorithms described herein may be implemented by appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

“Software” may refer to prescribed rules and/or instructions used to operate a computer. Examples of software may include: code segments in one or more computer-readable languages; graphical and or/textual instructions; applets; pre-compiled code; interpreted code; compiled code; and computer programs. An operating system or “OS” is software that manages computer hardware and software resources and provides common services for computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CS S), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™, SQL, Python, or other compilers, assemblers, interpreters or other computer languages or platforms.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “non-transitory computer readable medium” includes, but is not limited to, a hard drive, compact disc, flash memory, volatile memory, random access memory, magnetic memory, optical memory, semiconductor-based memory, phase change memory, optical memory, periodically refreshed memory, and the like; however, the non-transitory computer readable medium does not include a pure transitory signal per se.

A “computer system” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a plurality of computers and associated devices that may be connected by communication channels to facilitate communication and resource sharing. A network may involve permanent connections such as cables or temporary connections such as those made through telephone, cable, wireless or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include, but are not limited to, an internet, such as the Internet or World Wide Web; an intranet; a local area network (LAN); a wide area network (WAN); a virtual private network (VPN); Internet of Things (IoT); a peer-to-peer (P2P) network; Blockchain; and a combination of networks, such as an internet and an intranet. Exemplary networks may operate with any of a number of protocols, such as Transmission Control Protocol (TCP), Internet protocol (IP), Internet Address Protocol (IP Address), asynchronous transfer mode (ATM), and/or synchronous optical network (SONET), user datagram protocol (UDP), IEEE 802.x, etc.

Exemplary networks may operate with any of a number of protocols such as, but not limited to, Transmission Control Protocol (TCP), Internet protocol (IP), Internet Address Protocol (IP Address), asynchronous transfer mode (ATM), Near Field Communication digital protocol, and/or synchronous optical network (SONET), user datagram protocol (UDP), IEEE 802.x, etc.

A “server” can refer to computer hardware or computer software (or a computer program) that provides functionality for other computer programs or devices, often referred to as “clients.” Such architecture is typically referred to as the client-server model. Servers can provide various functionalities, often called “services,” such as sharing data or resources among multiple clients, or performing computation for a client. For example, a single server can serve multiple clients, and a single client can use multiple servers. A client process may run on the same device or may connect over a network to a server on a different device. Among the types of servers used today are database servers, file servers, mail servers, print servers, web servers, game servers, and application servers.

An “application programming interface” (API) is an interface that defines interactions between multiple software applications or mixed hardware-software intermediaries. An API defines the kinds of calls or requests that can be made, how to make them, the data formats that should be used, the conventions to follow, etc. An API can also provide extension mechanisms so that users can extend existing functionality in various ways and to varying degrees. An API can be entirely custom, specific to a component, or designed based on an industry-standard to ensure interoperability. Through information hiding, APIs enable modular programming, allowing users to use the interface independently of the implementation. A Web API is an application programming interface for either a web server or a web browser.

“Video” may refer to motion pictures represented in analog and/or digital form. Examples of video may include television, movies, image sequences from a camera or other observer, and computer-generated image sequences. Video may be obtained from, for example, a live feed, a storage device, an IEEE 1394-based interface, a video digitizer, a computer graphics engine, or a network connection.

A “multiplayer video game” is a video game in which more than one person can play in the same game environment at the same time, either locally or online over the internet. Multiplayer games usually require players to share a single game system or use networking technology to play together over a greater distance. Players may compete against one or more human contestants, work cooperatively with a human partner to achieve a common goal, or supervise other players' activity.

A “first-person shooter game” is a genre of shooter video games centered on gun and other weapon-based combat in a first-person perspective, with the player experiencing the action through the eyes of the protagonist and controlling the player character in a three-dimensional space. The genre shares common traits with other shooter games, and in turn falls under the action game genre. First person shooter games have been in use since the early 1990s and have become increasingly popular over the past three decades.

A “battle royale game” is an online multiplayer video game genre that blends the survival, exploration, and scavenging elements of a survival game with last-man-standing gameplay. Battle royale games involve dozens to hundreds of players, who start with minimal equipment and then must eliminate all other opponents while avoiding being trapped outside of a shrinking “safe area”, with the winner being the last player or team alive.

“Cryptocurrency” (or crypto currency) is a digital asset designed to work as a medium of exchange that uses strong cryptography to secure financial transactions, control the creation of additional units, and verify the transfer of assets. Cryptocurrencies are a kind of alternative currency and digital currency (of which virtual currency is a subset). Cryptocurrencies use decentralized control as opposed to centralized digital currency and central banking systems. The decentralized control of each cryptocurrency works through distributed ledger technology, typically a blockchain, that serves as a public financial transaction database. Exemplary cryptocurrency platforms and/or protocols include, but are not limited to, Bitcoin, Ethereum, Ripple Consensus Network, Hyperledger, R3's Corda, and Symbiont Distributed Ledger.

“Blockchain” refers to a system in which a record of transactions made on a block chain such as, but not limited to, Bitcoin and Etherium are maintained across several computers that are linked in a peer-to-peer or other network.

Embodiments of the system and method of conducting online video game tournaments and matches may include more than one apparatus or system for performing the operations disclosed herein. An apparatus or system may be specially constructed for the desired purposes, or it may comprise one or more general-purpose devices selectively activated or reconfigured by a program stored in the device. Moreover, embodiments of the system and method of conducting online video game tournaments and matches may employ differing appearances and/or interfaces to achieve a customized look.

Embodiments of the interactive system and method of conducting online video game tournaments and matches may also be implemented in, or in a combination of, hardware, firmware, and software. Such embodiments may be implemented as instructions stored on a machine-readable medium, which may be read and executed by a computing platform to perform the operations described herein.

Unless specifically stated otherwise, and as may be apparent from the following description and claims, it should be understood that throughout this application's specification, descriptions utilizing terms such as “recording, “processing,” “computing,” “calculating,” “determining,” or the like, refer to the actions and/or processes of a computer, computing system, or any similar electronic computing device which manipulates and/or transforms data represented as physical quantities within the computing system's registers and/or memories into other data similarly represented as physical quantities within the computing system's memories, registers or other such information storage, transmission or display devices.

Aspects of the exemplary interactive system and method of conducting online video game tournaments and matches will be described below with reference to flowchart illustrations and/or block diagrams of methods, steps, apparatus (systems) and computer program products according to embodiments of the invention. Persons skilled in the art will understand that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the exemplary system and method of conducting online video game tournaments and matches. It will become readily apparent to persons skilled in the art that each block in the flowchart or block diagrams may represent a module, segment, or portion of code, which comprises one or more executable instructions for implementing the specified logical function(s). It will also be readily apparent to persons skilled in the art that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order.

It will also be understood by persons skilled in the art that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram blocks.

When a single device or article is described herein, it will be readily apparent to persons having skill in the art that more than one device or article or/machine (whether or not they cooperate) may be used in place of a single device or article or machine. Similarly, where more than one device or article or machine is described herein (whether or not they cooperate), it will be readily apparent that a single device/article may be used in place of the more than one device or article. Likewise, the functionality and/or the features of a device or article or machine may be alternatively embodied by one or more other devices or articles or machines which are not explicitly described as having such functionality and/or features. Thus, other embodiments of the present invention need not include a specific device in and of itself.

As is well known to those skilled in the art, many careful considerations and compromises typically must be made when designing the optimal manufacture or commercial implementation of such a system and method of conducting online video game tournaments and matches. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

Systems will be described and provided with means and methods for providing and implementing an interactive system and method of conducting online video game tournaments and matches. The exemplary interactive system and method of conducting online video game tournaments and matches will now be described in detail with reference to embodiments thereof as illustrated in the accompanying drawings.

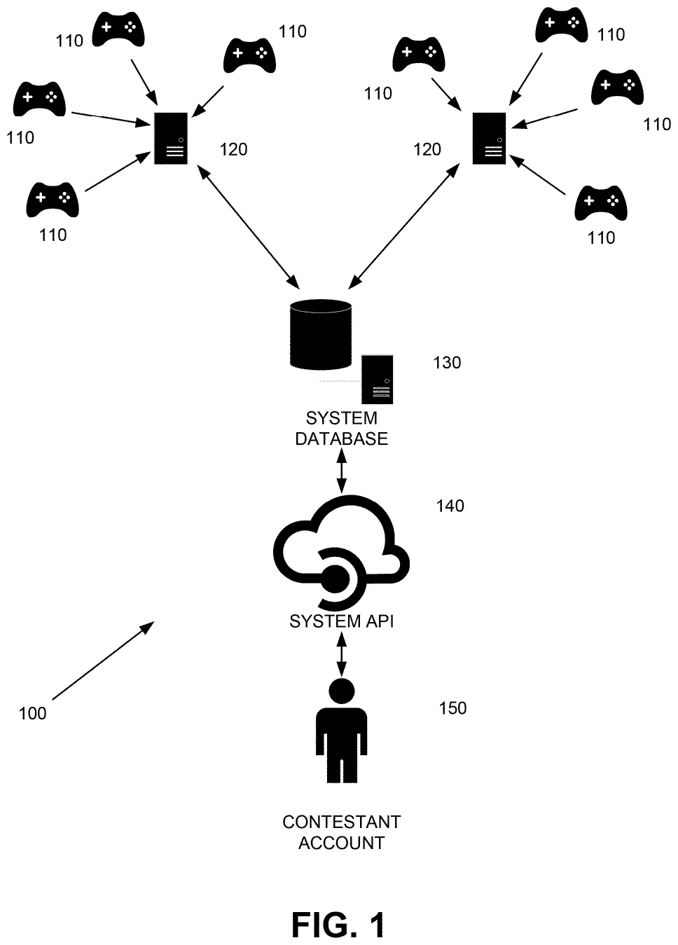

FIG. 1 illustrates a block diagram of an exemplary system and method of conducting online video game tournaments and matches 100 in accordance with an embodiment of the invention. In an embodiment of the invention, the system 100 includes a plurality of gaming servers 120. The gaming servers 120 are divided based upon certain criteria. The gaming servers 120 include both regional and/or global contestants 110 who may wish to play in a local online, regional online or global online gaming tournament. Alternatively, within the spirit and scope of the invention, the system 100 may only include exclusively local, exclusively regional, or exclusively include global tournaments with regional or global servers. The gaming servers 110 are also dedicated to particular game manufacturers or a particular category of games. The game servers can be operated by gaming publishers and/or who, in turn, provide online video game tournaments and matches. Alternatively, the game servers can be operated by third-party providers of online video game tournaments and matches.

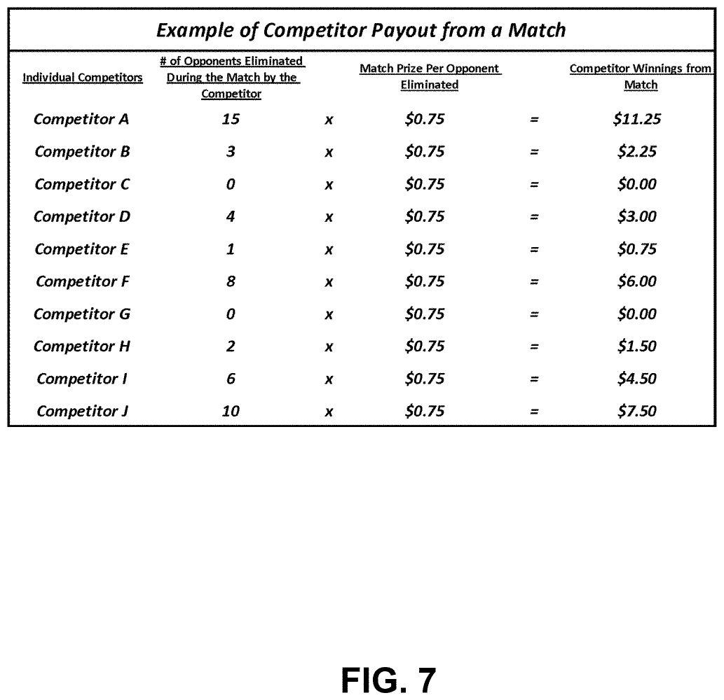

In the system 100, contestants 110 individual match performance statistics are transmitted into a system database 130 by remote (i.e. first- or third-party API or other data transmission method) or manual means. The system API 140 analyzes the system database 130 and calculates and the determines the number of opponents eliminated by each of the contestants 110 during a typical tournament or match. The performance statistics are also compared against the other online gaming tournament contestants 110 and that calculation may be used to determine a player's skill level and to award a player other monetary or non-monetary prizes. Contestants 110 are then paid prize money into their digital accounts 150. Contestants are paid a percentage of their entry fee, a percentage of the match prize pool, or a set amount for every opponent eliminated by each contestant during the tournament or match, thus awarding the contestants prize money on a “pay-per-kill” basis (or a pay-per-kill prize distribution) (see FIG. 7 for example of contestant payouts). Such a configuration of hardware and software allows for operators of the exemplary system and method of conducting online video game tournaments to utilize payment methods via numerous systems known and appreciated in the art.

In one embodiment of the system 100, the system API 140 is stored on one or more servers within the system 100 in accordance with one or more exemplary embodiments of the present invention. The server can take the form of a computer server, and more specifically a web server. The server can include ROM, operating system and software instructions, RAM, central processor unit (CPU), network interface to connect the server storing the API 140 to the plurality of gaming servers 120 and a data storage device. In one embodiment of the invention, a conventional personal computer or computer workstation with sufficient memory and processing capabilities can be used as the server. Alternatively, multiple interconnected servers can also serve as the server. Alternatively, multiple connected servers can exist in the cloud as a cloud-based application.

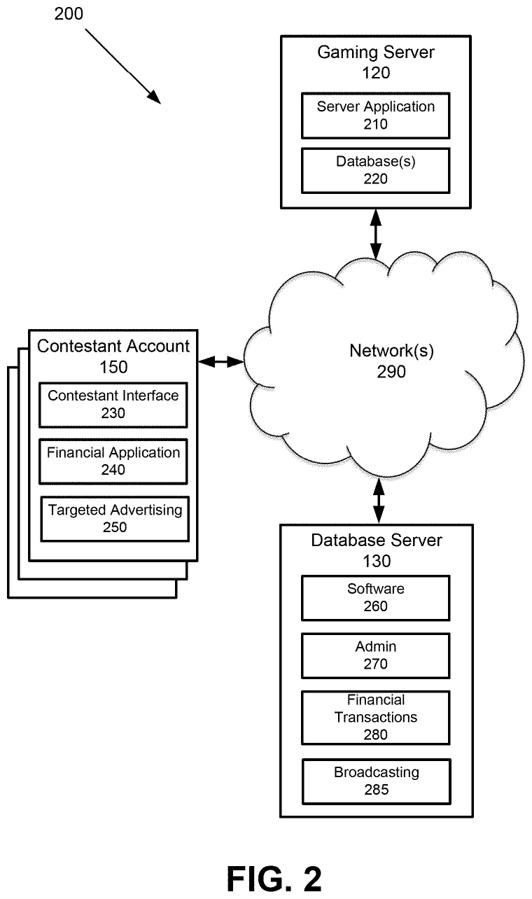

FIG. 2 illustrates a network diagram 200 for a system and method of conducting online video game tournaments and matches 100, according to an embodiment of the invention. The online gaming system may comprise at least one gaming server 120 or a plurality of gaming servers which hosts and/or executes software that manages online video game functions (e.g., recording scores, statistics etc.). The gaming server 120 may comprise dedicated servers, or may instead comprise cloud instances, which utilize shared resources of one or more servers. These servers or cloud instances may be collocated and/or geographically distributed. In some embodiments, the system 100, including the gaming server 120, will typically be located in a localized geographic region such as, but not limited to, an esports arena, esports gaming location, a college campus, a local or regional establishment, or simply a locally run server. Persons skilled in the art will understand that these new esports competition locations are often conducted over a local area network or LAN. The smaller network usually has very little lag and higher quality features such as esports arenas. Because competitors must be physically present, local area networks or LANs serve to help ensure fair play by allowing direct scrutiny of competitors. Such scrutiny helps prevent many forms of cheating, such as unauthorized hardware or software modification. The physical presence of competitors helps create a more social atmosphere at LAN events. Many gamers organize LAN parties or visit venues such as, but not limited to, internet café s, and many major tournaments are conducted over LANs. However, in other implementations, the gaming server 120 could be located outside of a localized geographical region (e.g., at a regional or central office, in the cloud, etc.). It must be understood, though, that the gaming server 120, the database server 130, and the contestant account 150 need not be in the same location to function.

The gaming server 120 may comprise or be communicatively connected to a server application 210 and/or one or more databases 220. In addition, the gaming server 120 may be communicatively connected to video gaming platforms 110 via one or more networks 290. Each gaming platform 110 may also be communicatively connected to one or more contestant accounts 150 via network(s) 290. In one embodiment of the invention, a gaming publisher, service provider, and/or developer gaming service provider could host their own online gaming tournament with their own proprietary server applications (e.g. their own video game) on their own gaming servers 120. In another embodiment of the invention, a third party can host an online gaming tournament by accessing a gaming publisher's server 120 through the gaming publisher's API. In another embodiment of the invention, the gaming tournament can be hosted at a particular location such as, but not limited to, an esports arena with data obtained from a gaming server to be displayed on public displays such as large-screen video displays. In other embodiments of the invention, neutral referees can simply tally the number of opponents eliminated by hand counting or through software applications. The gaming server can provide individual match data to the database server via API.

Network(s) 290 may comprise a local area network LAN and/or a wide area network WAN (e.g., the Internet) and can comprise a private and/or public network. For example, in an implementation in which the entire system 200 is located within a gaming establishment, such as an esports arena or internet cafe, network(s) 290 may consist of a single local area network. In contrast, in an implementation in which the gaming server 120 is remotely located (e.g. in the cloud or at a remote location), network(s) 290 may comprise both a public, wide area network that connects the gaming server 120 to a private, local area network (e.g., via a gateway), and the private, local area network which may comprise contestant accounts 150, a system database 130, and a database server 140. The system 100 can be implemented in location-specific venues or can be implemented as a purely online system.

Gaming servers 210 may communicate with the database server 130 and/or contestant accounts 150 using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. Persons having skill in the art will appreciate that numerous transmission protocols can be employed in a successful implementation of the system and method of conducting online video game tournaments and matches. While gaming server 210 is illustrated as being connected to various systems through a single set of network(s) 290, the gaming server 210 may be connected to the various systems via different sets of one or more networks. For example, the gaming server 210 may be connected to the database server 130 via a first network, but may be connected to contestant accounts 150 via a second, different network. Furthermore, while only a single gaming server 120, a few contestant accounts 150, and one database server application 130 are illustrated, the infrastructure may comprise any number of gaming servers 120, contestant accounts 150, and database server applications 130. However, in some scenarios, it may be desirable for a system to have only a single gaming server 120 and a single database server 130 and multiple contestant accounts 150.

The gaming server may comprise any type or types of gaming and/or computing devices capable of wired and/or wireless communication, including without limitation, gaming hardware and/or server platforms, desktop computers, laptop computers, tablet computers, smart phones or other mobile phones, electronic kiosks, and/or the like. The database server 130 may execute client instructions which communicates with server application 210 to provide a graphical user interface for contestant accounts 150, admin accounts 170, and broadcasting applications 285. Contestant account applications 230 may be “thin,” in which case processing is primarily carried out server-side by server application 210 on the gaming server 120. For example, contestant account 150 may be a browser application which renders the graphical user interface generated by either the gaming server application 210 or software 260 from the database server 130. Gaming server application 210 may transmit or serve one or more screens of the graphical user interface in response to requests from contestant account 150. In some embodiments, these screens may be served in the form of a wizard, in which case two or more screens may be served in a sequential manner, and one or more of the sequential screens may depend on an interaction of the user with one or more preceding screens. The requests to gaming server 120 and the responses from the gaming server application 210, including the screens of the graphical user interface, may both be communicated through network(s) 290 using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 290) that are locally and/or remotely accessible to gaming server 110. In an embodiment, the contestant account 150 may comprise a touch panel display which allows users (e.g., players or contestants) to perform touch operations to input elements of the graphical user interface. Alternatively, the contestant account 150 may comprise a non-touch-sensitive display with standard hardware inputs. Non limiting examples include PC gaming platforms, tablets, and smartphones.

The gaming server 210 may comprise, be communicatively coupled with, or otherwise have access to one or more database(s) 220. For example, the gaming server 210 may comprise one or more database servers which manage one or more databases 220. A contestant account 150 or server application 210, executing on the gaming server 120, may submit data (e.g., user data, form data, etc.) to be stored in database(s) 220, and/or request access to data stored in database(s) 220. Any suitable database may be utilized, including without limitation MySQL™, Oracle™ IBM™, Microsoft SQL™ Access™, and the like, including cloud-based databases and proprietary databases. Data may be sent to a server 210, for instance, using the well-known POST request supported by HTTP, via FTP, and/or the like. This data, as well as other requests, may be handled, for example, by server-side web technology, such as a servlet or other software module (e.g., comprised in server application 210), executed by such server 210.

The gaming server 120 and the contestant accounts 150 may be configured to host third-party devices, such as those in the XBox® system provided by Microsoft® Corporation of Redmond, Wash., the Sony® Playstation® system provided by Sony Corporation of America of New York, N.Y., or the Switch™ system provided by Nintendo of America. of Redmond, Wash. In such an embodiment, the database server 130 or a plurality of database servers may communicate with third-party gaming server (e.g., gaming server 210 and contestant accounts 150) via software residing the database server 130 and/or the third-party gaming devices. By way of example, and not limitation, software 260 on the database server 130 may communicate directly gaming server devices via an application programming interface (API) provided by a gaming publisher on the database server 130. In another non-limiting example, software 260 on the database server 130 may communicate with the third-party gaming and gaming server devices via an application programming interface (API) provided by third-party devices or other software provided on the database server 130.

The contestant account 150 can be accessed through a contestant interface 230. Persons skilled in the art will understand that a contestant interface can assume numerous configurations and appearances, with a plurality of contestant accounts being accessed on a computer having at least one processor, memory, and an interface. Such a contestant interface can be accessed on typical networked computing devices such as, but not limited to, personal computers, gaming consoles, smartphones, tablets, smart televisions, and kiosks. A contestant account can be accessed from a home or mobile computing environment or can be accessed from a platform provided at a gaming venue such as, but not limited to, an esports venue. In embodiments of the invention, the contestant interface can be accessed via web browser or through a customized software application. The contestant account can display results of current tournaments or matches. The contestant account can further display video captured results sent from the database server 140. The contestant account can further display results of prior matches and provide a user with game metrics and statistics stored on a database server. In other embodiments of the invention, a social media portal can be implemented with the ability to share metrics such as wins, performances, video caputres, screen captures, pay per kill statistics and the like on various social media platforms such as, but not limited to, Twitch, Instagram, Twitter and TikTok. In other embodiments of the invention, a social portal is integrated into the contestant account 150 itself with the ability to share metrics, wins, performances, video captures, screen captures, pay per kill statistics and the like among users of the exemplary system and method of conducting online video game tournaments and matches. The contestant account can provide a financial application 240 for contestants to pay entry fees and receive payouts. By way of example, and not limitation, a contestant can provide funds from a financial institution or cryptocurrency wallet which are recorded on the database server 130 or plurality of database servers and processed as payouts upon completion of a pay-per-kill tournament. Persons skilled in the art will readily appreciate that tournament entry fee transactions may be performed through conventional online banking techniques, through specific software provided to each contestant account 150, or may be made with cryptocurrency according to cryptocurrency protocols and recorded in a blockchain. The contestant account will also be able to provide for targeted advertising 250 from other companies. A gaming server 120 and a database server 130 can communicate either uni- or bi-directionally with the contestant account 150.

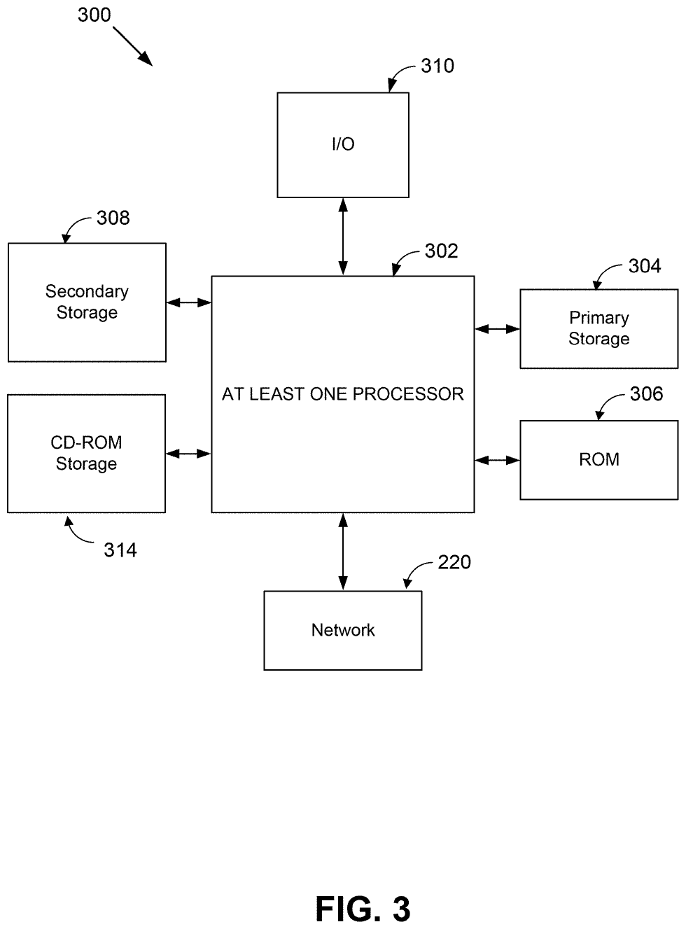

FIG. 3 illustrates a typical computer system that, when appropriately configured or designed, may serve as a computer system for which the system and method of conducting online video game tournaments and matches, and the components thereof, may be embodied. The computer system 300 includes at least one processor 302 (also referred to as central processing units, or CPUs) that may be coupled to storage devices including a primary storage 306 (typically a random-access memory, or RAM), a primary storage 304 (typically a read-only memory, or ROM). CPU 302 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 304 acts to transfer data and instructions uni-directionally to the CPU and primary storage 306 typically may be used to transfer data and instructions in a bi-directional manner. The primary storage devices discussed previously may include any suitable computer-readable media such as those described above. A mass storage device 308 may also be coupled bi-directionally to CPU 302 and provides additional data storage capacity and may include any of the computer-readable media described above. Mass storage device 308 may be used to store programs, data and the like and typically may be used as a secondary storage medium such as a hard disk. It will be appreciated that the information retained within mass storage device 308, may, in appropriate cases, be incorporated in standard fashion as part of primary storage 306 as virtual memory. A specific mass storage device such as a CD-ROM 314 may also pass data uni-directionally to the CPU. In such an embodiment, the CPU can reside in a personal computer, a gaming device, a gaming server, a database server, or it could reside in a specific location such as an esports arena or other suitable gaming venue, the instructions for operating each machine being stored as memory in primary storage 304, 306 or mass storage 308. It will be appreciated by persons having skill in the art that other cloud storage systems can readily integrate into such a computer system.

The CPU 302 or multiple CPUs may also be coupled to an interface 310 that connects to one or more input/output devices such as track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 302 optionally may be coupled to an external device such as a gaming server, a database server, or any computer or telecommunications or internet network using an external connection shown generally as a network 290, which may be implemented as a hardwired or wireless communications link using suitable conventional technologies. With such a connection, the CPU might receive information from the network, or might output information to the network in the course of performing the method steps described in the teachings of the present invention.

It will be understood by persons having skill in the art that memory storing computer readable instructions that, when executed by the at least one processor, cause the system and method of conducting online video game tournaments and matches by at least one processor in a database server, a gaming server, or contestant account to perform specific functions across a network. The invention can be further implemented as machine readable instructions detailing a method for operating an system and method of conducting online video game tournaments and matches comprising the steps of providing contestants, collecting a required entry fee from contestant digital accounts, organizing players into a match, beginning the match, collecting statistics from a match, reviewing statistics from the match and tallying contestant metrics such as opponents eliminated and/or assist count, and paying out contestants according to match metrics.

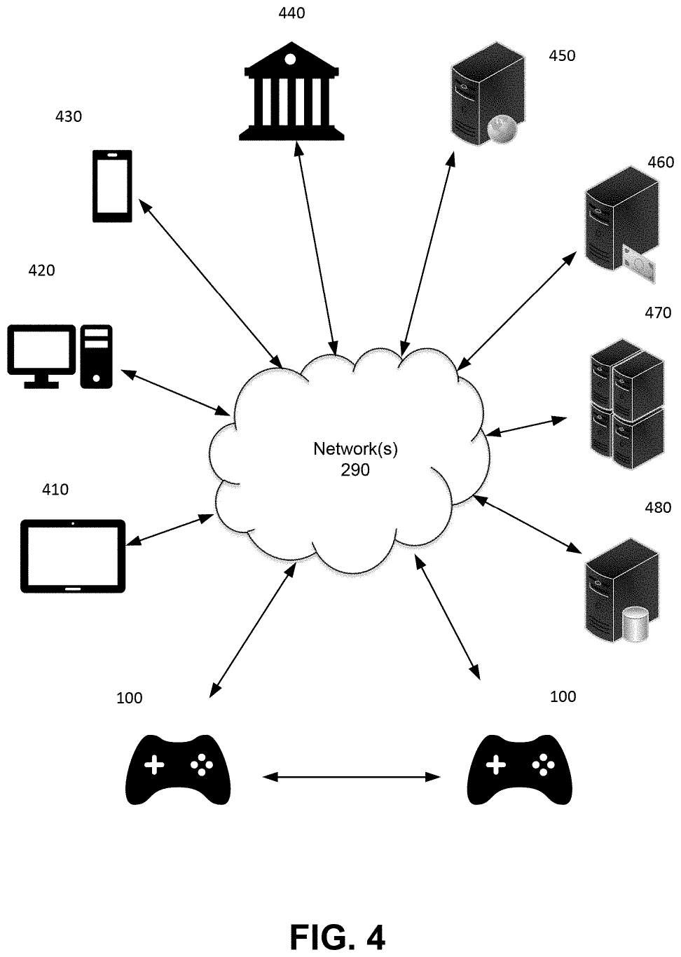

FIG. 4 illustrates a network diagram in which the exemplary system and method for conducting online video game tournaments and matches can or may be implemented. In addition to a basic gaming network and being able to network from gaming machine to gaming machine, the system and method for conducting online video game tournaments and matches may network both bi- and unidirectionally with tablet form gaming devices 410, desktop computer systems 420, mobile devices 430 belonging to both contestants and admins alike, financial institutions 440 for recording transactions and processing payments, web servers including gaming servers 450, ecommerce servers 460, application servers including gaming servers 470, and database servers 480. Persons having skill in the art will appreciate that the exemplary system and method for conducting online video game tournaments capability to network with video gaming servers offers a greater level of capability in recording individual gaming statistics.

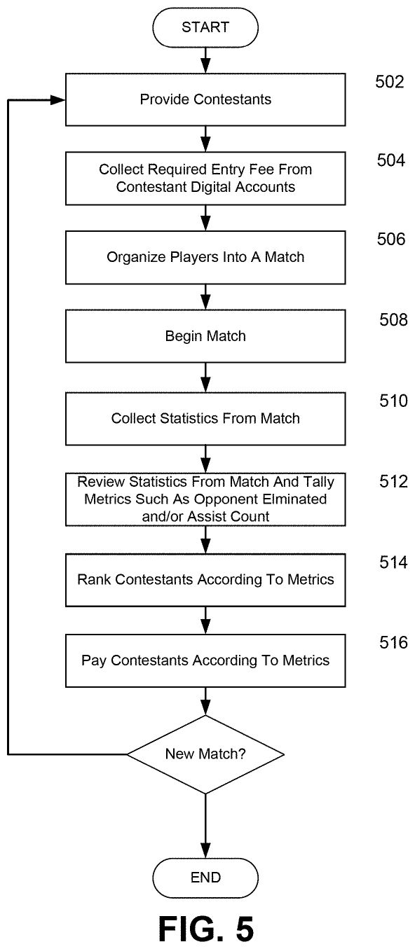

FIG. 5 illustrates a flowchart depicting a general method for conducting online video game tournaments and matches in accordance with an embodiment of the present invention. The method involves the recruitment of contestants 502, followed by the collection of the required entry fee from the contestant digital accounts 504, and the creation of a match prize pool. Contestants are then organized into a server 506 of a third-party game. Contestants then compete in a match on a server 508. Contestant performance statistics are then collected 510 either manually by an admin or electronically through a software application and transmitted to the system database 130 by remote (i.e. first- or third-party API or other data transmission method) or manual means. Following a match, the system API 140 reviews statistics from the match and tallies game metrics such as, but not limited to, the number of opponents eliminated by each contestant and/or assist count 512. The API or admin is able to rank contestants according to game metrics 514 such, but not limited to, opponents eliminated or assists. The API or an admin then determines the winning contestant based on the contestant with the highest number of opponents eliminated, and it pays contestants a percentage of their entry fee, a percentage of the match prize pool, or a set amount for every opponent eliminated by each player during the tournament or match 516, thus awarding contestants 110 prize money on a “pay-per-kill” basis (or a pay-per-kill prize distribution). The system API 140 then transmits the funds directly into contestant digital accounts 150. In alternative embodiments of the invention, admins or judges can tally metrics such as opponents eliminated or provide other metrics such as style points and easter eggs found and share results through the database server 130 or in real time.

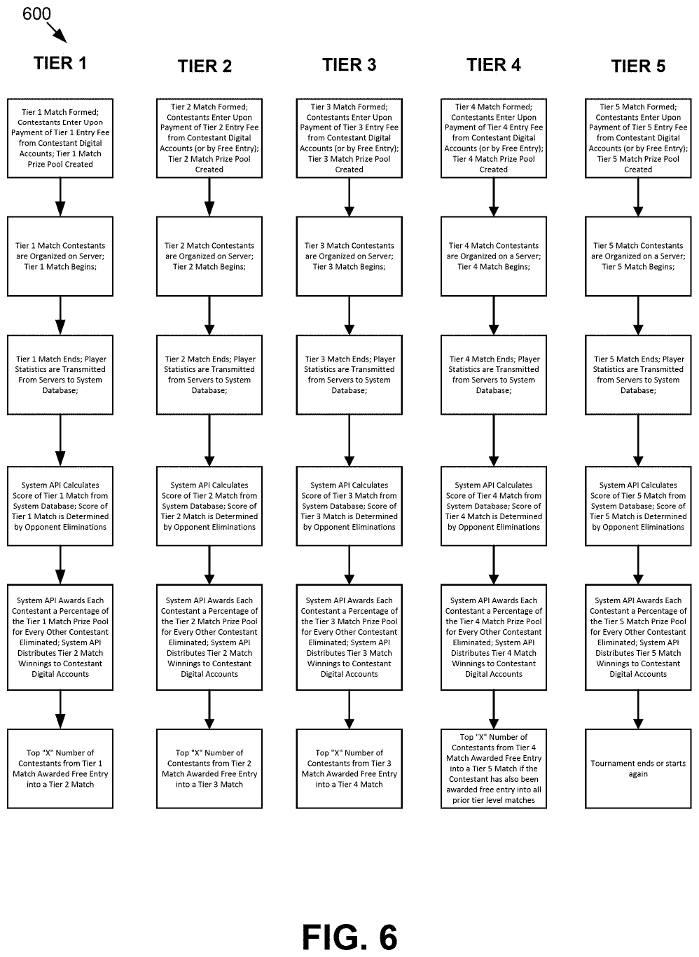

FIG. 6 is a block diagram of an exemplary tournament conducted in an embodiment of the invention. By way of example, and not limitation, a pay per kill tournament 600 involves more than one match in multiple different tiers with each tier having an increased match entry fee requirement. Players through the contestant account 150 can enter an exemplary tournament via one of two methods; (1) manually by using a user interface of a website, mobile applications, or other deemed user interface applications in the contestant account 150, or (2) automatically by having enabled an automatic entry feature, which can algorithmically enter a user to a tournament based on defined and agreed upon conditions such as, but not limited to, promotional features, once the system detects that the player is playing in a specific tournament location or using specific gaming software.

In an embodiment of the invention, the tournament 600 operates in a fashion where, at each tier, the top set number of contestants (for example, the top three contestants) in each match based on opponents eliminated receives a free entry to the next highest tier. This continues tier to tier, based on the set number of tiers until the final tier, resulting in contestants being able to earn their way from the lowest tier to the highest tier. Persons having skill in the art will readily appreciate that the number of tiers may vary based on factors such as, but not limited to, the number of contestants or prize pool. In the final tier match, contestants can earn a free entry into the final tier match by receiving a free entry into all prior tiers (i.e. the contestant started at the bottom tier, placed in the top three, and placed in the top three contestants in a Tier 1, 2, 3, and 4 match), with all other contestants purchasing their entry into the final tier match from their digital accounts.

Upon completion of the final tier match, the tournament is completed, contestant statistics are transmitted from the server 110 to the database 130, and the system API 140 and/or database server 130 calculates the number of opponents eliminated by each contestant during the final tier match by each contestant, and all contestants are paid a percentage of their entry fee, a percentage of the match prize pool, or a set amount for every opponent eliminated by each contestant during the match. Such a tournament structure awards contestants prize money on a “pay-per-kill” basis (or a pay-per-kill prize distribution) (see FIG. 7 for example of contestant payouts). The system API 140 then transmits the funds directly into contestant digital accounts 150.

The tournament 600 may also be divided into micro tournaments, where no free entries are awarded to competitors at the completion of a lower tier match. Thus, any number of different monetary based tiers will then be opened to competitors. Each match regardless of tier in the tournament 600 would thus be its own, individual micro-tournament for competitors with a pay-per-kill prize distribution (see FIG. 4 for example of contestant payouts).

FIG. 7 is an example of competitor payouts in accordance with an embodiment of the invention. In the preferred embodiment of the invention, a single elimination style “battle royale” first person shooter video game is played. After a match, prizes are awarded. By way of example, and not limitation, the table provided is intended to illustrate one example of competitor payouts, including the number of competitors and the amounts awarded per opponent eliminated in a match. By way of example, and not limitation, such a table can be displayed on the contestant account 150 interface. Alternatively, such battle royale tournaments can be hosted from local venues such as esports venues or internet cafes. The system is configured to provide a game ready tournament environment.

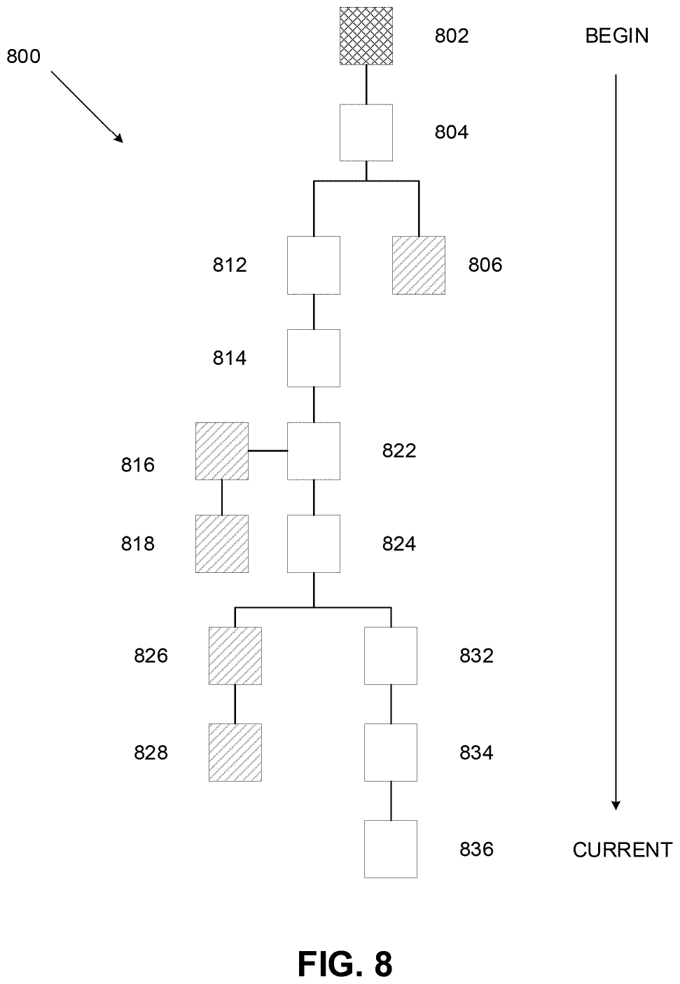

FIG. 8 is a diagram illustrating a simple blockchain. Blocks in the main chain 802, 804, 812, 814, 822, 824, 832, 834, 836 are the longest series of blocks that go from the beginning block 802 to the current block 836. For any block in the blockchain, there is only one path from the beginning block 802 to the current block 836. Blocks 806, 816, 818, 826, 828 are blocks that are not in the longest chain. Because this is a distributed system, blocks 816, 818, 826, 828 are typically created only a few seconds apart from the main chain. Whenever a fork happens, generating computing nodes builds onto which ever block is received first in time. Therefore, the short chain of blocks 116, 118, 126, 128 are not used.

In another example, each user of the blockchain in FIG. 8 is a member or subscriber. Only after a set number of members or subscribers vote on the addition of a new block in the block chain, is a block chain added. In this member-based system, the short chains of block 116, 118, 126, 128 are not created.

The blockchain 800 implementation consists of two kinds of records—transactions and blocks. Transactions are the actual data stored in the blockchain. As shown the data in each of the blockchain is encrypted as shown graphically by the lock. In one example, the data in each block represents a single transaction. In another example, data in each block represents more than on transaction that is dividable into sections within each block, such as, the wager of a single hand from a gaming session or an image in series of images. Transactions are created by users or participants using the system. The blocks are recorded to confirm when and in what sequence a certain transaction become journaled as part of the blockchain database.

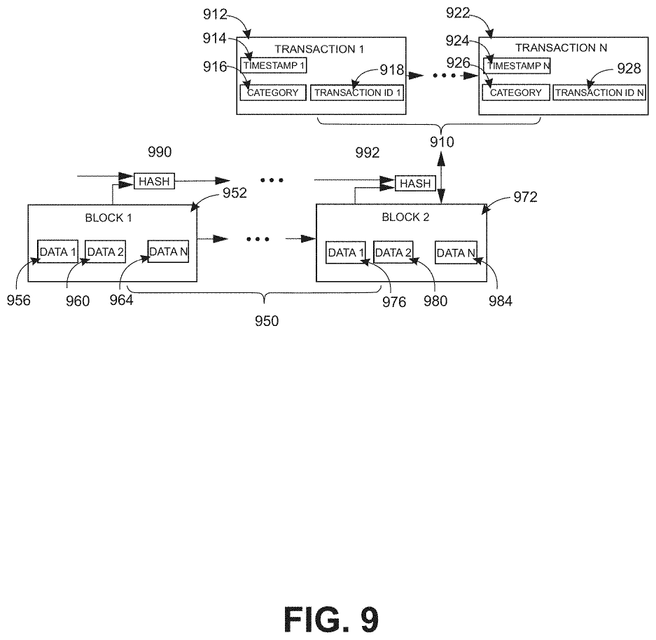

FIG. 9 is a functional diagram 900 illustrating details of each block and transaction in the blockchain of FIG. 8. Shown are two kinds of record blocks 910 and transactions 950. The transactions 950 are actual data stored in the blockchain 900. The blocks 910 are records of transactions. In this example transactions 910 are all associated with block 2 972. Other transactions (not shown are associated with block 1 952).

Record blocks 910 represent a series of transactions 912 through 912 as shown for transactions 1 through transaction n respectively. Each block 910 representing a transaction typically includes a timestamp 914, 924 of the transaction. A unique transaction identifier 918, 928 is also shown. This transaction id can be search for a specific item in the transactional database management system. Also shown is an optional category for the transaction 916, such as wager, marker, financial, employment, etc. to associate with the additional data in the transactions 950 described below.

A hash function 990 and 992 is shown as part of the record blocks 910. In one implementation of a blockchain, the previously hash function 990 is input to a subsequent hash function 992, along with the transaction 1 as shown. This ensures that there has been no tampering or alteration of the data in the record blockchain.

Transactions 950 shown in block 1 through block N, (952, 972) contain user or additional data 956, 960, 964, 976, 980, 984. The additional data can represent any multimedia data including text, audio, video, images, financial statements, and more.

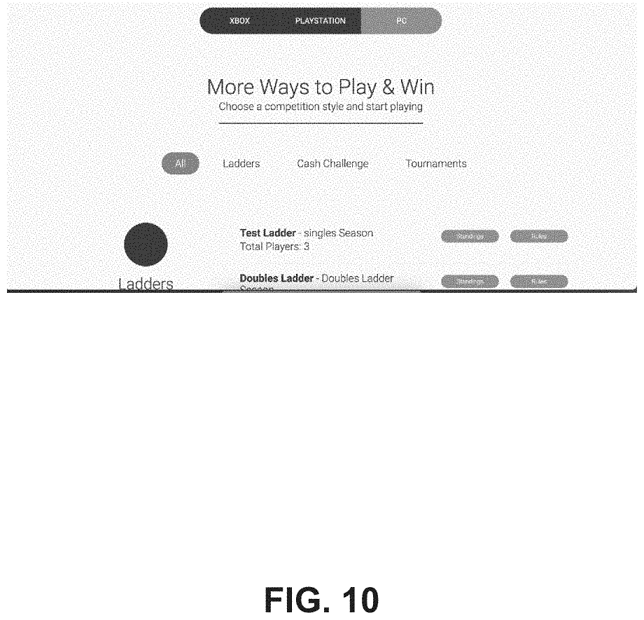

FIG. 10 illustrates a sample user interface for a contestant account in accordance with an embodiment of the invention. A user can access a contestant account 150 through a web browser or software application configured for personal computers, tablets and smartphones. Such a contestant interface can be accessed on typical networked computing devices such as, but not limited to, personal computers, gaming consoles, smartphones, tablets, smart televisions, and kiosks. A contestant account can be accessed from a home or mobile computing environment or can be accessed from a platform provided at a gaming venue such as, but not limited to, an esports venue. In embodiments of the invention, the contestant interface can be accessed via web browser or through a customized software application. The contestant account can display and select different types of gaming platforms used such as, but not limited to, personal computer, Sony® PlayStation® and Microsoft® Xbox®. The contestant account can display results of current tournaments or matches. The contestant account can allow a user to select tournaments and matches offered on various different networks hosted by a tournament organizer or a third party. The contestant account can provide league and ladder play as well. The contestant account can further display video captured results sent from the database server 140. The contestant account can further display results of prior matches and provide a user with game metrics and statistics stored on a database server. In other embodiments of the invention, a social media portal can be implemented with the ability to share metrics such as wins, performances, video caputres, screen captures, pay per kill statistics and the like on various social media platforms such as, but not limited to, Twitch, Instagram, Twitter and TikTok. In other embodiments of the invention, a social portal is integrated into the contestant account 150 itself with the ability to share metrics, wins, performances, video captures, screen captures, pay per kill statistics and the like among users of the exemplary system and method of conducting online video game tournaments and matches. The contestant account can provide a financial application 240 for contestants to pay entry fees and receive payouts. By way of example, and not limitation, a contestant can provide funds from a financial institution or cryptocurrency wallet which are recorded on the database server 130 and processed as payouts upon completion of a pay-per-kill tournament. Persons skilled in the art will readily appreciate that tournament entry fee transactions may be performed through conventional online banking techniques, through specific software provided to each contestant account 150, or may be made with cryptocurrency according to cryptocurrency protocols and recorded in a blockchain. The contestant account will also be able to provide for targeted advertising 250 from other companies. A gaming server 120 and a database server 130 can communicate either uni- or bi-directionally with the contestant account 150.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the system and method of conducting online video game tournaments and matches, other equivalent or alternative methods of implementing the system and method of conducting online video game tournaments and matches according to the present invention will be apparent to those skilled in the art. Various aspects of the system and method of conducting online video game tournaments and matches have been described above by way of illustration, and the specific embodiments disclosed are not intended to limit the invention to the particular forms disclosed. The particular implementation of the system and method of conducting online video game tournaments and matches may vary depending upon the particular context or application. By way of example, and not limitation, the system and method of conducting online video game tournaments and matches described in the foregoing was principally directed to online gaming tournaments and specific gaming establishments. However, similar techniques may instead be applied to other remote systems which implementations of the present invention are contemplated as within the scope of the present invention. Additionally, differing combinations and arrangements of display, gaming, interface and input/output technologies may be implemented to achieve a more desirable appearance. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the system and method of conducting online video game tournaments and matches are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A system for conducting online video game tournaments and matches comprising:
a. a plurality of networked gaming devices, each gaming device having a processor, memory and an interface programmed to communicate with a plurality of gaming servers;
b. a plurality of contestant digital accounts, each of said plurality of contestant accounts being accessible on a networked computer system, the said system having a processor, memory, and an interface;
c. a plurality of gaming servers, each gaming server having an application programming interface programmed to communicate with the said plurality of gaming devices;
d. a plurality of database servers, each database server having an application programming interface programmed to communicate with the said plurality of gaming servers and said plurality of contestant digital accounts;
e. memory storing computer readable instructions that, when executed by at least one processor in the said plurality of gaming servers or plurality of database servers to cause the system for conducting an online video game tournament and matches comprising at a plurality of gaming devices, a plurality of gaming servers, a plurality of database servers and a plurality of contestant digital accounts, for each of a plurality of steps including—
i. collecting a required entry fee from the at least one contestant digital account;
ii. providing a contestant pool for a given tournament or match;
iii. organizing contestants into a tournament or match;
iv. beginning the match;
v. collecting statistics from a match;
vi. reviewing statistics from the match and tallying game metrics;
vii. ranking contestant scores based tallied game metrics; and
viii. distributing prizes among contestant pool according to game metrics.

2. The system of claim 1 wherein the plurality of gaming servers is hosted by a gaming developer.

3. The system of claim 1 wherein the plurality of gaming servers is hosted by a third-party.

4. The system of claim 1 wherein the plurality of contestant accounts is accessed on a computer having at least one processor, memory, and an interface.

5. The system of claim 1 wherein the at least one contestant digital account can access a financial institution so as to transfer monetary funds to the organizer and conductor of an online video game tournament or match.

6. The system of claim 1 wherein the at least one contestant digital account can access a cryptocurrency wallet so as to transfer cryptocurrency funds to the organizer and conductor of an online video game tournament or match.

7. The system of claim 1 wherein cryptocurrency transactions are recorded in a blockchain.

8. The system of claim 1 wherein the at least one database server is capable of live streaming results of an online video game tournaments and matches to the plurality of customer accounts.

9. The system of claim 1 wherein the at least one database server is capable of communicating directed advertisements to each of the plurality of contestant accounts.

10. A system for conducting first-person shooter video game tournaments and matches having a pay-per-kill feature comprising:
a. a plurality of networked gaming devices in a specific geographic area, each gaming device having a processor, memory and an interface programmed to communicate with a plurality of gaming servers;
b. a plurality of contestant digital portal accounts, said plurality of contestant accounts being accessible on a networked computer system, the said system having a processor, memory, and an interface;
c. a plurality of gaming servers, each gaming server in communication with the said plurality of networked gaming devices, the said plurality of gaming servers having an application programming interface programmed to communicate with the said plurality of networked gaming devices in a specific geographic area;
d. a plurality of database servers, each database server having an application programming interface programmed to communicate with the application programming interface of the said plurality of gaming servers and said plurality of contestant digital accounts;
e. memory storing computer readable instructions that, when executed by at least one processor in the said plurality of gaming servers or plurality of database servers to cause the system for conducting an online video game tournament and matches comprising a plurality of networked gaming devices, a plurality of contestant digital accounts, a plurality of gaming servers, and a plurality of database servers, for each of a plurality of steps including
i. collecting a required entry fee from the at least one contestant digital account;
ii. providing a contestant pool for a given tournament or match;
iii. organizing contestants into a tournament or match;
iv. beginning the match;
v. collecting statistics from a match;
vi. reviewing statistics from the match and tallying game metrics;
vii. ranking contestant scores based tallied game metrics;
viii. distributing prizes among contestant pool according to game metrics;

11. The system of claim 10 wherein the game metrics are tallied by number of opponents eliminated.

12. The system of claim 10 wherein the plurality of gaming servers is hosted by a gaming developer.

13. The system of claim 10 wherein the plurality of gaming servers is hosted by a third-party.

14. The system of claim 10 wherein the plurality of contestant accounts is accessed on a computer having at least one processor, memory, and an interface.

15. The system of claim 10 wherein the at least one contestant digital account can access a financial institution so as to transfer monetary funds to the organizer and conductor of an online video game tournament or match.

16. The system of claim 10 wherein the at least one contestant digital account can access a cryptocurrency wallet so as to transfer cryptocurrency funds to the organizer and conductor of an online video game tournament or match.

17. The system of claim 10 wherein cryptocurrency transactions are recorded in a blockchain.

18. The system of claim 10 wherein the at least one database server is capable of live streaming results of an online video game tournaments and matches to the plurality of customer accounts.

19. The system of claim 10 wherein the at least one database server is capable of communicating directed advertisements to each of the plurality of contestant accounts.

20. A method for conducting an online video game tournament or match comprising the steps of:
A. Providing a system for conducting online video game tournaments and matches comprising:
a. at least one gaming device, said gaming device having a processor, memory and an interface;
b. at least one a gaming server having at least one processor, memory and an interface, said at least one gaming server networked with the at least one gaming device;
c. at least one database server having at least one processor, memory and an interface;
d. at least one contestant digital account; and
e. memory storing computer readable instructions that, when executed by at least one processor in the gaming server cause the system for conducting an online video game tournament and matches comprising at least one gaming device, at least one gaming server, at least one database server and at least one client digital account to perform the functions of conducting an online video game match or tournament;
B. collecting a required entry fee from the at least one contestant digital account;
C. providing a contestant pool for a given tournament or match;
D. organizing contestants into a tournament or match;
E. beginning the match;
F. collecting statistics from a match;
G. reviewing statistics from the match and tallying game metrics;
H. ranking contestant scores based on game metrics; and
I. distributing prizes among contestant pool according to metrics.
